(19) United States
(12) Patent Application Publication
(10) Pub. No.: US 2015/0208767 A1
(43) Pub. Date: Jul. 30, 2015

(54) Button Fastener

(71) Applicant: Buttonon LLC, Park City, UT (US)

(72) Inventor: Justin O. Shafer, Phoenix, AZ (US)

(73) Assignee: Buttonon LLC, Park City, UT (US)

(21) Appl. No.: 14/605,520

(22) Filed: Jan. 26, 2015

Related U.S. Application Data
(60) Provisional application No. 61/932,127, filed on Jan. 27, 2014.

(51) Int. Cl. A44B 1/18; B29C 39/02; B29C 39/00; B65D 63/10

(52) U.S. Cl. CPC A44B 1/185; B65D 63/1027; B29C 39/026; B29C 39/003; B29L 2031/7272

(57) ABSTRACT

A fastener for quickly affixing a button with at least a hole to a fabric and a method for manufacturing the fastener are disclosed. The fastener comprises a needle, one or preferably multiple ratchets, and a locking hub—all connected by the primary thread and the secondary thread. Attaching a button can be quick and easy with a lock that works as a beginning-and-ending knot, formed by a ratchet and the locking hub. When an embodiment of the fastener comprises multiple ratchets, a break point may be provided between two ratchets to quickly rid of the needle and the primary thread after the button is attached to the fabric. An embodiment with multiple ratchets may also accommodate buttons of various thicknesses and sizes.

### CROSS-REFERENCE TO RELATED APPLICATION

The present application claims priority to a co-pending U.S. provisional patent application entitled “Device to reattach a button to fabric,” having a Ser. No. 61/932,127, filed on Jan. 27, 2014, which is entirely incorporated herein by reference.

### BACKGROUND

When a button falls off a shirt, the shirt may become unwearable. Replacing or reattaching a button can be complicated, time consuming, and inconvenient. Traditional means for re-fastening a detached button include a needle and a matching thread or a bulky separate tool or machine that requires certain skills to use.

Some have attempted to improve the traditional means for fastening buttons by various devices, such as the U.S. Patent Publication No. 2012/0260489 by Hamilton (“Hamilton”). However, the results are not as satisfying as the needle-and-thread combination. For instance, the clamp in Hamilton can only fit for buttons with a specific distance between the button holes. Additionally, the clamp in Hamilton cannot be adjusted based on the various sizes/thicknesses of the button or fabric. On the one hand, it cannot work when the thickness of the button plus the fabric exceeds the clamp's length. On the other hand, when the button and fabric are thin, the attached button would become too loose.

Therefore, a fastener that not only quickly reattaches a detached button without the use of a needle and thread but also is adjustable to accommodate buttons and fabrics of various thickness and/or sizes is desired.

### SUMMARY

The structure, overall operation and technical characteristics of the present invention will become apparent with the detailed description of preferred embodiments and the illustration of the related drawing as follows.

The invention is incorporated in a fastener for quickly affixing a button with at least a hole to a fabric and a method for manufacturing the fastener. The fastener comprises a needle, one or preferably more ratchets, and a locking hub—all connected by thread-like elements called the primary thread and the secondary thread. The needle is configured to penetrate the fabric and pass through the button hole(s). The primary and secondary threads are configured to connect the components and work like ordinary threads when affixing a button using a traditional needle-and-thread method. The locking hub alone may be configured to work as a beginning knot while the one or more ratchets and the locking hub together are configured to quickly create a lock that is an equivalent of an ending knot after the button is attached to the fabric.

An embodiment of the fastener may comprise a plurality of ratchets that are coupled linearly. Each of the ratchets of this embodiment is tapered on one end toward the needle, with the other end expanding and protruding away from the needle. For instance, an exemplary ratchet may have a shape of a cone. The ratchets may include a lead ratchet coupled to the primary thread, an end ratchet, and a break point between the lead and the end ratchets. The break point is configured to easily detach the needle and the primary thread from the fastener after the button is affixed to the fabric. For instance, the break point may have the smallest diameter of the whole fastener so that a user may simply pull or wiggle the excess elements until the fastener breaks at the break point. In a preferred embodiment, the break point is right between the lead ratchet and its following ratchet.

In another embodiment, the secondary thread may comprise a fabric lock configured to prevent the fabric from moving away from the locking hub during the sewing process. Like the ratchets of the previous embodiment, the fabric lock may be tapered toward the needle while protruding toward the locking hub and creating a blunt 90 degree drop off. Therefore, after the fabric lock passes through the fabric, the fabric may be “locked” between the protruding end of the fabric lock and the locking hub.

In one embodiment of the fastener, the locking hub may further comprise a base with a hole in the middle, multiple flexible, angled tabs extending from the base toward each other, and a shroud extending from the base and surrounding the tabs. In order to lock the ratchets, there is only one correct direction for the ratchets in this embodiment to pass through the locking hub: from the base to the top portion of the shroud that is away from the base. In some embodiments, the shroud may have an indication of the correct direction, such as an arrow sign or words.

In a preferred embodiment, the locking hub is coupled to the secondary thread at the top portion of the shroud for creating a lock that does not move freely and cause irritation to the wearer of the clothing. In another preferred embodiment, the top portion of the shroud may be higher than the tabs in order to hide a tip of the broken point after the needle and the primary thread are detached.

In an embodiment with multiple ratchets including a lead ratchet and an end ratchet, each of the ratchet may be cone-shaped with a slope. The slope of the lead ratchet is preferably milder than the slope of the end ratchet, as well as those for the rest, in order to widen a hole in the fabric for the following ratchets to easily pass through and to prevent or minimize thread breaks in the fabric.

A preferred embodiment of the fastener is made of a one-piece molded plastic, such as Nylon 6. But a person skilled in the art would know that various materials and combinations of materials may be used.

One object of this invention is to provide a means to quickly and permanently attach a button to a clothing.

Another object of this invention is to provide a button fastener that may be used with buttons of various dimensions and fabrics of various thicknesses.

### BRIEF DESCRIPTION OF THE DRAWINGS OR PICTURES

FIG. 1 shows a perspective view of a preferred embodiment of the fastener.

FIG. 2 shows a side view of the preferred embodiment.

FIG. 3 shows a top view of the preferred embodiment.

FIG. 4 shows a side sectional view of a portion of the preferred embodiment.

FIG. 5 shows a perspective view of a portion of the preferred embodiment.

FIGS. 6A-D show steps to use another embodiment of the fastener.

### DESCRIPTION OF THE EMBODIMENTS

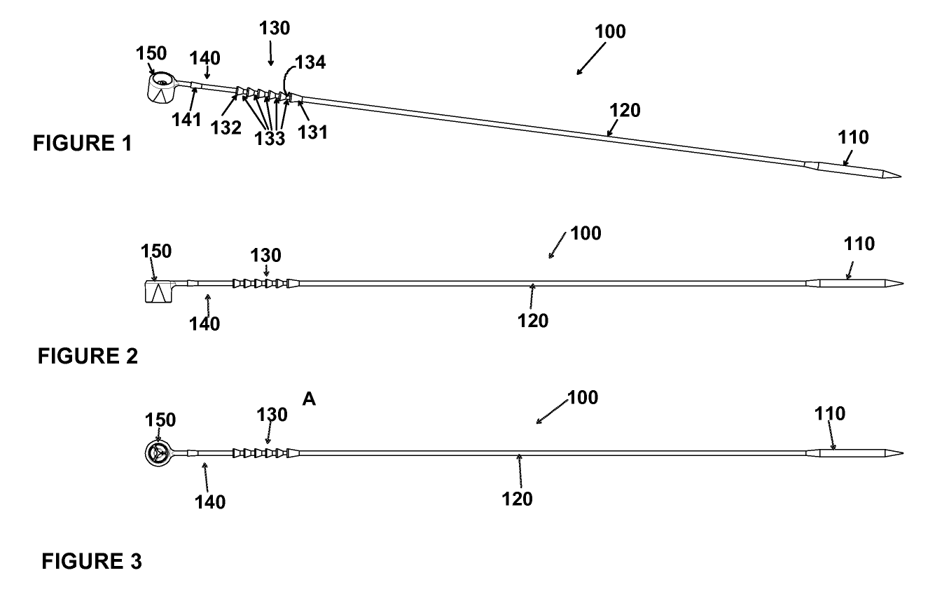

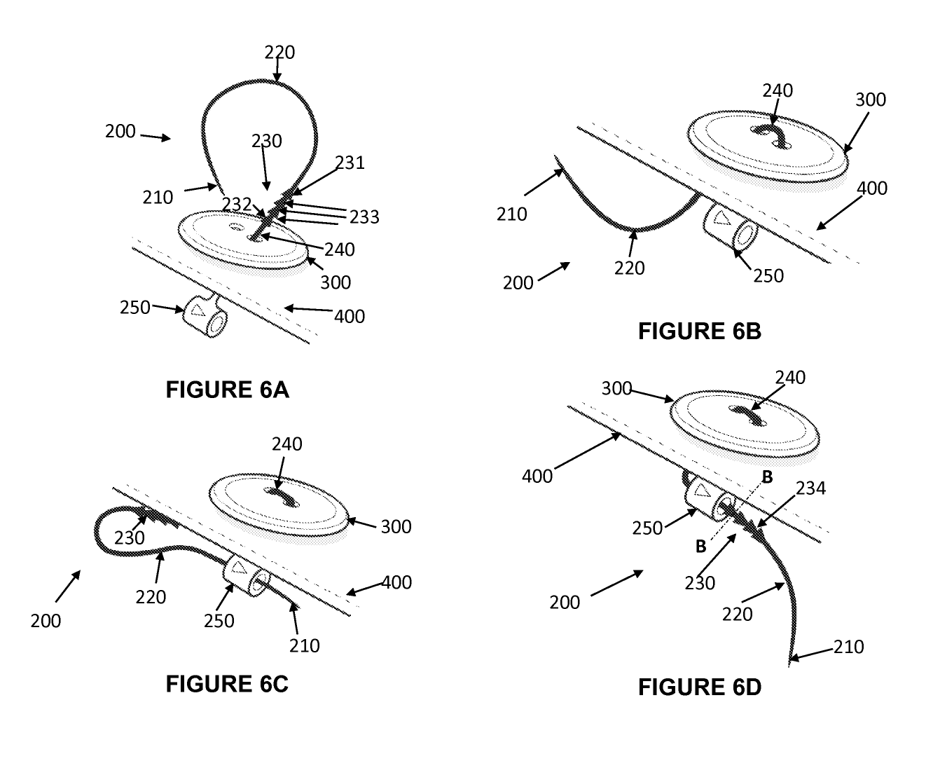

A preferred embodiment of the fastener is illustrated in FIGS. 1-5. Another exemplary embodiment is illustrated in FIGS. 6A-D, including the steps to use the embodiment. The preferred embodiment (100) in FIGS. 1-5 has a needle (110), a primary thread (120), a plurality of ratchets (130), a secondary thread (140), and a locking hub (150).

As stated above, a needle is used to penetrate fabrics, and it thus must be sufficiently rigid. The preferred embodiment (100) in FIGS. 1-5 is made of a one-piece molded plastic. The plastic is preferably flexible for sewing yet rigid for penetrating the fabrics, such as Nylon 6. But any suitable materials or combinations thereof may be adopted.

In addition to materials, the diameter (thickness) and length of a needle (110) affect its rigidness. A thicker needle would be more rigid, but it would not pierce through fabrics as easily as a thinner needle. Moreover, the longer a needle is, the easier it is for the user to hold. But since users tend to hold an embodiment at the end of the needle, as its length increases, the needle would be easier to bend as well. Experiments show that for penetrating common fabrics, such as cotton shirts, nylon pants, and wool sweaters, a needle preferably has a diameter between 1.3 mm and 1.4 mm and a length between 15 mm and 18 mm. For instance, the needle (110) of the preferred embodiment (100) has a 1.4 mm diameter and an 18 mm length.

The ratchets (130) of this preferred embodiment (100) are cone-shaped, with their tapered ends toward the needle (110). An embodiment of this invention may have a single ratchet, but multiple ratchets are preferred since an embodiment with multiple ratchets may accommodate buttons and fabrics with various thickness and/or dimensions. In addition, a ratchet (130) may be of various shapes as long as it can be used with a locking hub to form a lock. The shape of the ratchets (130) in this embodiment (100) is preferred because it would allow the ratchets (130) to pass through the locking hub (150) smoothly but not reverse back out. How this locking feature may be implemented is discussed below.

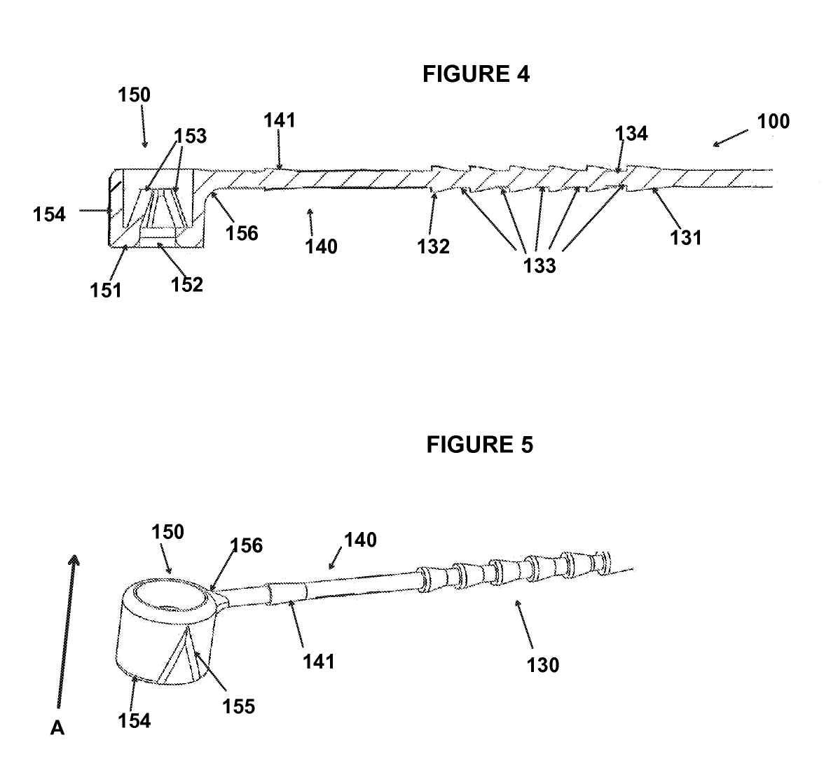

As shown in FIGS. 4-5, this embodiment (100) has multiple ratchets, including one leading ratchet (131) and an end ratchet (132). The leading ratchet (131) preferably has a slope milder than other ratchets so that the hole in the fabric that the embodiment is passing through would be widened smoothly for the following ratchets to pass through.

The ratchets (130) are linearly connected with valleys (133) between them. The valleys (133) of this embodiment (100) have a smaller diameter than those of the primary thread (120) and the secondary thread (140). At least a valley (133) of this embodiment (100), preferably the first one, is a break point (134). A break point is the weakest point of an embodiment so that the user may simply pull the primary thread (120) and needle (110) to detach them after the button is affixed without any tools such as a knife or scissors. In this preferred embodiment (100), the break point (134) has a smallest diameter (0.74 mm) among all the valleys (133) and is located between the lead ratchet (131) and its following ratchet. Alternate embodiments may adopt different techniques for creating a break point, such as using a different material or having holes through the break point to make it easy to break.

The ratchets (130) and the locking hub (150) of this preferred embodiment (100) together create a lock that works as an ending knot at sewing after at least one ratchet passes through the locking hub (150). The exemplary locking hub (150) comprises a base (151) with a central hole (152), three flexible, angled tabs (153), and a shroud (154). The tabs (153) extend from the base toward each other. When a ratchet (130) passes through the central hole (152) in a correct direction (arrow A in FIG. 5)—from the base (151) toward the direction the tabs (153) extend to, the ratchet (130) enters with its tapered end and gradually pushes the tabs (153) apart. After the ratchet (130) passes through, the tabs (153) close up behind the ratchet (130) at a valley (133) or the second thread (140) if the ratchet (130) is the end ratchet (132). As such, the ratchet (130) cannot move back out, and a lock is easily formed by the last ratchet (130) that passes through the tabs (153) and the tabs (153) together.

As stated above, after a lock is formed, the user may detach the needle (110), the primary thread (120), and optionally the ratchet(s) (130) other than the one that is part of the lock with or without tools. After detaching, a broken tip of the remaining portions may cause discomfort to the wearer of the clothing that the button is affixed to. Therefore, the locking hub (150) preferably has a shroud (154) extending from the base (151) and surrounding the tabs (153) for protecting the wearer. Also, as shown in FIG. 5, in order to show the user the correct direction (A), the shroud (154) preferably has an indication, such as the arrow sign (155).

In addition, the locking hub (150) is preferably connected to the secondary thread (140) at the shroud's (154) top portion (156) as in FIGS. 4-5. With the lock formed near the top portion (156), the locking hub (150) would be held in a loop formed by the secondary thread (140). As such, the locking hub (150) would lay flat against the fabric as well as the wearer's skin, with the shroud (154) contacting the wearer on a smooth side (left side as shown in FIG. 5) opposite to the upper portion (156) that connects to the secondary thread (140). If a lock were to be formed near the base (151), the locking hub (150) would not be in the loop but instead would protrude toward the wearer and move freely, potentially causing the wearer minor discomfort.

Additionally, in order to keep the fabric near the locking hub (150) without moving freely during the process of affixing the button, the secondary thread (140) preferably comprises a fabric lock (141). The fabric lock (141) of this preferred embodiment (100) is a bump tapered toward the needle (110). The preferred fabric lock (141) is cone-shaped with a length of 2 mm, a diameter of 1.1 mm, and a blunt 90 degree drop toward the locking hub (150). The secondary thread (140) may preferably be thinner at the portion between the fabric lock (141) and the locking hub (150) than that between the end ratchet (132) and the fabric lock (141), thus making it easier to “lock” the fabric.

Furthermore, the secondary thread (140) as a whole is preferably as thin as possible, or at least as thin as the primary thread (120), so that the secondary thread (140) would bend easily. In addition, for a button with more than one hole, the secondary thread (140) is exposed outside the buttonhole dividers after the button is affixed, and therefore, the thinner the secondary thread (140) is, the less obvious it would be.

Another exemplary embodiment of the fastener (200) is illustrated in FIGS. 6A-D. The embodiment (200) comprises a needle (210), a primary thread (220), a plurality of ratchets (230) with a lead ratchet (231), an end ratchet (232), multiple valleys (233) including a break point (234), a secondary thread (240), and a locking hub (250). In FIG. 6A, the needle (210), the primary thread (220), and the ratchets (230) have been pushed through the fabric (400) and a first hole of the button (300). Then in FIG. 6B, the needle (210) is pushed back through the second hole of the button (300) and the fabric (400), bringing the primary thread (220) and the ratchets (230) (not shown) with it. It is preferred that the user pulls the embodiment (200) tight so that the locking hub is flush to the fabric (400). Now that the button (300) is coupled to the fabric (400), an ending lock is created by holstering the needle (210) and pulling it through the locking hub (250) in FIGS. 6C-D. After at least one ratchet (230) passes through the locking hub (250), the user may cut the excess off up to line B-B or break the excess by wiggling. The exemplary break point (234) of this embodiment (200) is located next to the lead ratchet (231), but it may alternatively be located at line B-B. In an alternate embodiment with a plurality of break points, every valley may be a break point.

While the invention has been described by means of specific embodiments, numerous modifications and variations could be made thereto by those ordinarily skilled in the art without departing from the score and spirit disclosed herein. For instance, the materials of the elements of an embodiment may be different, such as an embodiment with a metal needle and the rest plastic. Various dimensions and shapes of the elements in an embodiment may be adopted, such as pyramid-shaped ratchets or a square locking hub. Finally, the number of ratchets, break points, and tabs in the locking hub of different embodiments may vary as well.

1. A fastener for attaching a button with a hole to a fabric comprising:
a) a needle for penetrating the fabric and passing through the hole of the button;
b) a primary thread coupled to the needle;
c) a plurality of linearly coupled ratchets each being tapered toward the needle and protruding away from the needle, the ratchets having:
1) a lead ratchet coupled to the primary thread,
2) an end ratchet, and
3) a break point between the lead and the end ratchets;
d) a secondary thread coupled to the end ratchet; and
e) a locking hub coupled to the secondary thread configured to allow the needle, the primary thread, and the ratchets to pass through and lock the ratchets by preventing the ratchets from backing out after the ratchets passing in a correct direction, wherein
the break point is configured to easily detach the needle and the primary thread from the fastener after one of the ratchets that is not the lead ratchet is locked by the locking hub and the button is affixed to the fabric.

2. The fastener in claim 1, wherein the secondary thread further comprises a fabric lock that is tapered toward the needle and protrudes toward the locking hub, configured to prevent the fabric from moving away from the locking hub after the fabric lock passing through the fabric.

3. The fastener in claim 1, wherein
a) the locking hub further comprises:
1) a base having a central hole for the ratchets to pass through,
2) a plurality of flexible, angled tabs extending from the base toward each other, the tabs spreading open when a ratchet is passing and closing up behind the ratchet that just passes, and
3) a shroud extending from the base and surrounding the tabs; and
b) the correct direction for the ratchets to pass through the locking hub is from the base to a top portion of the shroud that is away from the base.

4. The fastener in claim 3, wherein the locking hub is coupled to the secondary thread at the top portion of the shroud.

5. The fastener in claim 3, wherein the shroud further comprises an indication of the correct direction.

6. The fastener in claim 3, wherein the top portion of the shroud is higher than the tabs in order to hide a broken tip after the needle and the primary thread are detached.

7. The fastener in claim 1, wherein each of the ratchets has a slope, the slope of the lead ratchet being milder than the slope of the end ratchet in order to easily widen a hole in the fabric for the ratchets to easily pass through and prevent a thread break in the fabric.

8. The fastener in claim 1, wherein the break point is adjacent to the lead ratchet.

9. The fastener in claim 1 is made of a one-piece molded plastic.

10. The fastener in claim 1, wherein the secondary thread is thinner than the primary thread.

11. The fastener in claim 1, wherein the needle is 18 mm long.

12. A method for manufacturing a fastener for attaching a button with a hole to a fabric, the method comprising the steps of:
a) providing a mold for the fastener that comprises:
1) a needle,
2) a primary thread coupled to the needle,
3) a plurality of linearly coupled ratchets each being tapered toward the needle and protruding away from the needle, the ratchets having:
i) a lead ratchet coupled to the primary thread;
ii) an end ratchet; and
iii) a break point between the lead and the end ratchets,
4) a secondary thread coupled to the end ratchet, and
5) a locking hub coupled to the secondary thread configured to allow the needle, the primary thread, and the ratchets to pass through and lock the ratchets by preventing the ratchets from backing out after passing in a correct direction; and
b) curing a resin in the mold, wherein
the break point has a smallest diameter among the ratchets.

13. The method in claim 12, wherein the secondary thread further comprises a fabric lock that is tapered toward the needle and protrudes toward the locking hub and configured to prevent the fabric from moving away from the locking hub after the fabric lock passing through the fabric.

14. The method in claim 12, wherein
a) the locking hub further comprises:
1) a base having a central hole for the ratchets to pass through,
2) a plurality of flexible, angled tabs extending from the base toward each other, the tabs spreading open when a ratchet is passing and closing up behind the ratchet that just passes, and
3) a shroud extending from the base and surrounding the tabs; and
b) the correct direction for the ratchets to pass through the locking hub is from the base to a top portion of the shroud that is away from the base.

15. The method in claim 14, wherein the locking hub is coupled to the secondary thread at the top portion of the shroud.

16. The method in claim 14, wherein the shroud further comprises an indication of the correct direction.

17. The method in claim 14, wherein the top portion of the shroud is higher than the tabs in order to hide a broken tip after the needle and the primary thread are detached.

18. The method in claim 12, wherein each of the cone-shaped ratchets has a slope, the slope of the lead ratchet being milder than the slope of the end ratchet in order to easily widen a hole in the fabric for the ratchets to easily pass through and prevent a thread break in the fabric.

19. The method in claim 12, wherein the break point is adjacent to the lead ratchet.

20. The method in claim 12, wherein the secondary thread is thinner than the primary thread.

21. The method in claim 12, wherein the needle is 18 mm long.

22. A one-piece fastener for attaching a button with a hole to a fabric comprising:
a) a needle for penetrating the fabric and passing through the hole of the button;
b) a primary thread coupled to the needle;
c) a ratchet tapered toward while protruding away from the needle, and coupled to the primary thread;
d) a secondary thread coupled to the ratchet; and
e) a locking hub coupled to the secondary thread configured to allow the needle, the primary thread, and the ratchet to pass through and lock the ratchet by preventing the ratchet from backing out after the ratchet passing in a correct direction.
